(19) United States
(12) Patent Application Publication
(10) Pub. No.: US 2015/0006304 A1
(43) Pub. Date: Jan. 1, 2015

(54) LOCATION-BASED AND TIME-SENSITIVE GOODS RATINGS

(71) Applicant: International Business Machines Corporation, Armonk, NY (US)

(72) Inventors: Lee A. Carbonell, Flower Mound, TX (US); Tsz S. Cheng, Grand Prairie, TX (US); Jeffrey L. Edgington, Keller, TX (US); Pandian Mariadoss, Allen, TX (US)

(21) Appl. No.: 13/931,242

(22) Filed: Jun. 28, 2013

(51) Int. Cl. G06Q 30/02; G06Q 20/20

(52) U.S. Cl. CPC G06Q 30/0282; G06Q 20/208
USPC 705/16; 705/23

(57) ABSTRACT

A ratings device in a purchase environment receives a rating of goods, and writes the rating of goods to a physical medium. A point of sale device in the purchase environment reads the rating of goods from the physical medium and transmits the rating of goods to a ratings server. The ratings server can integrate and distribute the rating. The ratings device can include a scale configured to weigh a portion of the goods, logic configured to price the portion of goods based at least in part on the weight of the portion of goods, a user interface configured to receive a rating of goods of the type of the portion of goods, and a writer configured to write the rating to the physical medium.

### FIELD OF THE INVENTION

The present invention relates generally to rating goods, and more particularly to providing an online service for the gathering and dissemination of goods ratings from and to purchasers of goods in an environment where the goods can be bought from an enterprise.

### BACKGROUND

Customers commonly research goods rating and pricing information on the Internet before purchasing the goods. For example, prior to making a purchase of an appliance from an enterprise, a customer can research the appliance to determine its quality, according to numerous aggregated ratings, and what it costs at a number of online and brick-and-mortar sellers, including the enterprise, according to price-comparison websites. Such aggregated ratings can include ratings by professional consumer reporting companies, as well as crowd-sourced nonprofessional raters. Numerous techniques exist for aggregating ratings and for performing online price comparisons.

Enterprises commonly make use of such aggregated ratings and price comparisons to improve their own operations. Such aggregated ratings and price comparisons can be used as feedback to an enterprise for the purpose of improving goods and services. An enterprise may instruct a customer to access a web site for a survey of goods and services. Another method for enterprise feedback is for an enterprise to contract with a survey company to poll customers for it, either in person, by phone, by mail, or online. These survey methods are sometimes accompanied with incentives to try to get customers to participate. Participation can place a burden on the customer, and it can be difficult for an enterprise to appear responsive to feedback if a long process is involved.

### SUMMARY

Embodiments of the present invention provide for a program product, system, and method to perform location-based and time-sensitive ratings of goods. A ratings device in a purchase environment receives a rating of goods, and writes the rating of goods to a physical medium. A point of sale device in the purchase environment reads the rating of goods from the physical medium and transmits the rating of goods to a ratings server. The ratings server can integrate and distribute the rating. The ratings device can include a scale configured to weigh a portion of the goods, logic configured to price the portion of goods based at least in part on the weight of the portion of goods, a user interface configured to receive a rating of goods of the type of the portion of goods, and a writer configured to write the rating to the physical medium.

### BRIEF DESCRIPTION OF THE SEVERAL VIEWS OF THE DRAWINGS

FIG. 1 is a functional block diagram of a ratings environment in accordance with an embodiment of the present invention.

FIG. 2 is a functional block diagram of the ratings environment of FIG. 1 depicting ratings interactions in accordance with an embodiment of the present invention.

FIGS. 3A and 3B show flowcharts depicting steps followed during ratings interactions in accordance with an embodiment of the present invention.

FIG. 4 is a functional block diagram of a computer system in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

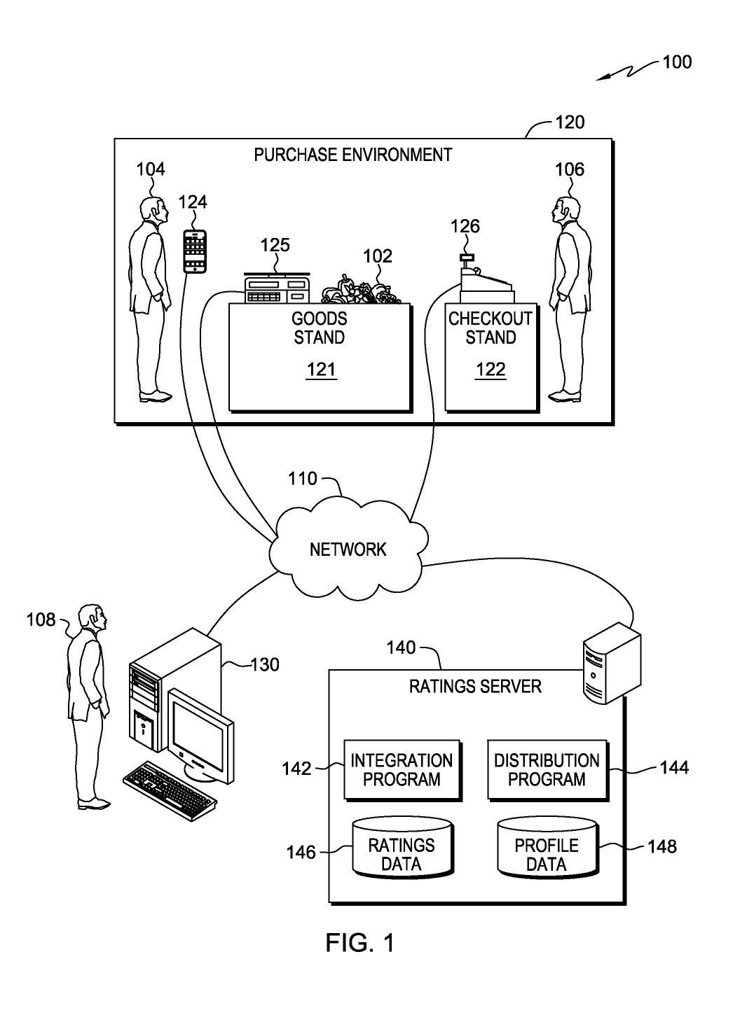

Referring now to FIG. 1, a functional block diagram of ratings environment 100 in accordance with an embodiment of the present invention is shown. Ratings environment 100 includes network 110, mobile device 124, ratings device 125, point of sale device 126, computer 130, and ratings server 140. Shown in ratings environment 100 is purchase environment 120, which itself includes mobile device 124, ratings device 125, and point of sale device 126, as well as checkout stand 122, goods stand 121, goods 102, person 104, and person 106. Shown outside of purchase environment 120 are computer 130 and ratings server 140, as well as person 108. As discussed in detail below, in purchase environment 120 person 104 can purchase goods 102, perform a location-based and time-sensitive rating of goods 102, and perform other activities. As further discussed in detail below, a rating of goods 102, or a ratings digest, can be integrated and distributed by ratings server 140.

Network 110 can be, for example, a local area network (LAN), a wide area network (WAN) such as the Internet, or a combination of the two, and can include wired or wireless connections. In general, network 110 can be any combination of connections and protocols that will support communications via various channels between mobile device 124, ratings device 125, point of sale device 126, computer 130, and ratings server 140 in accordance with an embodiment of the invention.

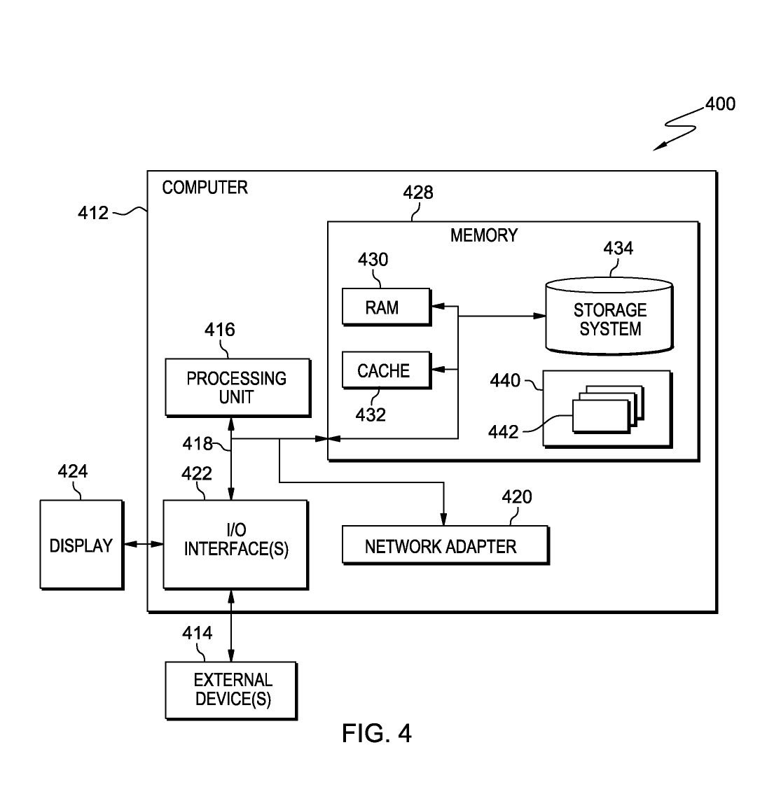

In various embodiments, each of mobile device 124, ratings device 125, point of sale device 126, computer 130, and ratings server 140 can include a laptop, tablet, or netbook personal computer (PC), a desktop computer, a personal digital assistant (PDA), a smart phone, a mainframe computer, or a networked server computer. Further, ratings server 140 can include computing systems utilizing clustered computers and components to act as single pools of seamless resources when accessed through network 110, or can represent one or more cloud computing datacenters. In general, each of mobile device 124, ratings device 125, point of sale device 126, computer 130, and ratings server 140 can be any programmable electronic device as described in further detail with respect to FIG. 4.

Purchase environment 120 can be any environment in which goods 102 are made available for sale by an enterprise. For example, in one embodiment the enterprise includes a grocer, and goods 102 include perishable (i.e., time-sensitive) fruits, vegetables, or meats for sale to customers (e.g., person 104, etc.) of the grocer. In another embodiment, the enterprise can be any enterprise involved in selling, or making available for sale, goods 102 of any type, either perishable or non-perishable. For example, in other embodiments, the enterprise can be a consumer retailer of clothes, appliances, electronics, hardware, software, or prepared meals, or a business-to-business seller (i.e., a wholesaler or supplier) of the same. Generally, goods 102 can include anything that has economic utility or satisfies an economic want, or anything grown, manufactured, or produced for sale. Person 106, an employee of the enterprise, assists customers with their purchases using point of sale device 126 at checkout stand 122. However, in one embodiment, point of sale device 126 is a self-checkout device, such that person 106 does not need to help person 104 with a purchase at checkout stand 122.

The enterprise operating purchase environment 120 makes available ratings device 125 and goods 102 at goods stand 121. For example, goods stand 121 can include a fruit stand, upon which goods 102 including fruit are available for perusal and purchase by person 104, and at which ratings device 125 is operable by person 104. In one embodiment, ratings device 125 includes a scale for weighing and pricing goods 102. For example, person 102 can place a portion of goods 102 onto ratings device 125, use ratings device 125 to weigh and price the portion, and further use ratings device 125 to print a label, (e.g., a writer or printer of ratings device 125 writes or prints a barcode or matrix code, etc.) including the weight and pricing information, readable at point of sale device 126. In various embodiments, instead of printing a label, ratings device 125 can write to a portable storage medium such as an RFID tag or flash drive, for example (e.g., a writer of ratings device 125 writes to a storage medium, etc.). In one embodiment, ratings device 125 retrieves current pricing information via network 110, while in another embodiment, ratings device 125 is not connected to network 110, and requires periodic manual pricing information updates by, e.g., person 106. In another embodiment, ratings device 125 does not include a scale for weighing and pricing goods 102, and serves instead as a standalone ratings device. In yet another embodiment, ratings device 125 does not include a scale for weighing and pricing goods 102, and instead includes a scanner for reading a label affixed to goods 102.

In various embodiments, person 104 can also rate goods 102 using mobile device 124 or point of sale device 126. Further, in one embodiment person 106, an employee of the enterprise, can rate goods 102 using point of sale device 126. In such various embodiments, each of ratings device 125, mobile device 124, and point of sale device 126 can have a user interface for receiving ratings such as ripe and unripe, fresh and stale, new and old, or ratings on a 10-point quality scale, for example. In various embodiments, such user interfaces can be limited to positive ratings, limited to negative ratings, or open to both positive and negative ratings. Further, in various embodiments, such user interfaces can include a registration or sign-up interface enabling person 104 to provide her or her email address or other contact information to receive ratings of goods 102 or ratings digests.

Ratings server 140 includes integration program 142, distribution program 144, ratings data 146, and profile data 148. In one embodiment, integration program 142 can handle data integration between the internal components of ratings server 140 and external sources of data, such as sources within purchase environment 120, and supports the normalization and quality of received data. Further, integration program 142 can de-duplicate received data and handle data transformation to normalize from different input sources. De-duplication of received data can include, for example, detecting and removing duplicate ratings entered by a single person at ratings device 125 in close succession. For example, if person 104 rates goods 102 twice on accident, integration program 142 can de-duplicate (i.e., remove) the second spurious rating. Normalizing data from different input sources can include, for example, reformatting data received from multiple enterprises into a single common data format, and unifying data received from multiple enterprises into a single standard (e.g., converting all units to metric, etc.).

In one embodiment, integration program 142 stores de-duplicated and normalized data in ratings data 146. Ratings data 146 can store various attributes along with ratings, such attributes including the item rated (e.g., an identification of goods 102, etc.), the date rated, the rating criteria (in one embodiment, rating criteria can vary based on the type of the item rated, e.g., ripe and unripe, fresh and stale, new and old, a 10-point quality scale, etc.), the identification of the person performing the rating, the location of the rated item (e.g., GPS coordinates, store address, position of goods stand 121 in purchase environment 120, etc.), the observed inventory level (e.g., how much or many of goods 102 are remaining at goods stand 121, etc.), the stock group or lot number of the rated item, and user comments (e.g., person 104 can enter freeform comments when rating goods 102, etc.).

In one embodiment, distribution program 144 distributes data in ratings data 146, via an included communication engine configured to deliver notifications and content via one or more of email, social media, SMS, web presence, or an API that enables programmatic access from other programs, for example. Distribution program 144 can distribute data in ratings data 146 in the form of ratings of particular goods 102, or of a ratings digest. A ratings digest can include a synopsis, summary, or statistical analysis of multiple ratings. For example, a ratings digest can include information about where the highest rated goods 102 of a specific type are located, information about how the ratings of various goods 102 have changed over time, or information about where the closest goods 102 that exceed a ratings threshold are located, for example. Generally, distribution program 144 can deliver information to mobile device 124, computer 130, or other devices, as discussed in detail below.

In one embodiment, integration program 142 and distribution program 144 can reference data stored in profile data 148. Data can be stored in profile data 148 to enable a user (e.g., person 104, etc.) to specify his or her preferences regarding both generating ratings (e.g., generate ratings received by integration program 142, etc.) and viewing ratings (e.g., view ratings or ratings digests sent by distribution program 144, etc.). Thus, profile data 148 can include data on each user's group or user membership definition, social media or anonymity or privacy preferences, filter criteria, item interest (e.g., which items should be listed for display to a user, etc.), location interest (e.g., which locations are listed by default to the user, etc.), ratings (e.g., minimum ratings that are listed for display to the user, etc.), amount of ratings, time of ratings (e.g., how recently a ratings was entered, for expiration purposes, etc.), keywords that the user is interested in, inventory levels (e.g., only show the user ratings with a certain amount of inventory in stock, etc.), method of delivery (e.g., email, social media, SMS, etc.), groups or users to specifically share with, and frequency of notifications (e.g., distribution program 144 can distribute new ratings or ratings digests to users continuously, hourly, daily, etc.).

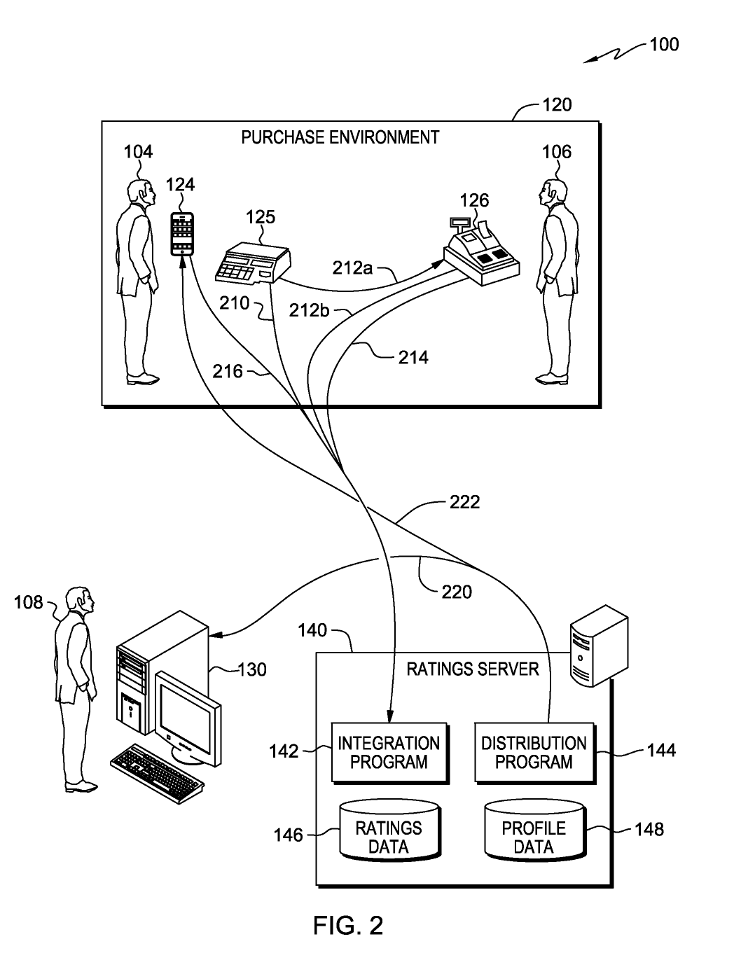

Referring now to FIG. 2, a functional block diagram of ratings environment 100 of FIG. 1 depicting ratings interactions 210, 212a, 212b, 214, 216, 220, and 222 in accordance with an embodiment of the present invention is shown. Although the depiction of network 110 is omitted from FIG. 2, it should be understood that each of ratings interactions 210, 212b, 214, 216, 220, and 222 (but not ratings interactions 212a) can entail one or more communications over network 110. It should further be understood that the present invention is not limited to ratings interactions 210, 212a, 212b, 214, 216, 220, and 222, and that additional interactions can be practiced. Further still, the depiction of goods 102, goods stand 121, and checkout stand 122 are omitted from FIG. 2 only for clarity.

During each of ratings interactions 210, 212a, 212b, 214, and 216, a rating of goods 102 is communicated from purchase environment 120 to integration program 142 of ratings server 140. For example, during ratings interaction 210 a rating of goods 102 is communicated from ratings device 125 to integration program 142. It should be understood that ratings interactions 210, 212a, 212b, 214, 216 can be performed in alternative embodiments, and may not all occur in a given embodiment (with the exception of ratings interactions 212a and 212b), as discussed in detail below.

During each of ratings interactions 220 and 222, a rating of goods 102, or a ratings digest, is communicated from distribution program 144 of ratings server 140 to computer 130 or mobile device 124. For example, during ratings interaction 220 a rating of goods 102, or a ratings digest, is communicated from distribution program 144 to computer 130. It should be understood that ratings interactions 220 and 222 can be performed in alternative embodiments, and may not all occur in a given embodiment, as discussed in detail below.

During ratings interaction 210, a rating of goods 102 is communicated from ratings device 125 to integration program 142. For example, if goods stand 121 is a fruit stand upon which goods 102 including fruit are available for perusal and purchase by person 104, person 104 can select a fruit of goods 102 and use ratings device 125 to weigh and price the fruit, as well as to rate the fruit, using a user interface of ratings device 125. For another example, if ratings device 125 does not include a scale and is a standalone ratings device, person 104 can select a fruit of goods 102 and use ratings device 125 to rate the fruit, using a user interface of ratings device 125. Upon receiving the entry of the rating of the fruit, ratings device 125 transmits the rating to integration program 142, to conclude ratings interaction 210.

During ratings interactions 212a and 212b, a rating of goods 102 is communicated from ratings device 125 to integration program 142 via point of sale device 126. For example, as above, person 104 can select a fruit of goods 102 and use ratings device 125 to weigh and price the fruit, as well as to rate the fruit, using a user interface of ratings device 125. Upon receiving the entry of the rating of the fruit, ratings device 125 prints a label, (e.g., a barcode or matrix code, etc.) including the weight and pricing information, as well as including the rating, readable at point of sale device 126. In an embodiment in which ratings device 125 is a standalone ratings device, the printed label includes only the rating. Person 104 attaches the printed label to the fruit, and concludes ratings interaction 212a by carrying the labeled fruit to point of sale device 126. At point of sale device 126, the printed label is scanned by point of sale device 126, and point of sale device 126 transmits the rating to integration program 142, to conclude ratings interaction 212b. Notably, because the printed label carries the rating from ratings device 125 to point of sale device 126, ratings interactions 212a and 212b do not require that ratings device 125 be coupled to network 110.

During ratings interaction 214, a rating of goods 102 is communicated from point of sale device 126 to integration program 142. For example, as above, person 104 can select a fruit of goods 102 and use ratings device 125 only to weigh and price goods 102, but not actually to rate goods 102. Ratings device 125 prints a label including the weight and pricing information readable at point of sale device 126. Person 104 attaches the printed label to the fruit, and carries the labeled fruit to point of sale device 126. At point of sale device 126, a rating for the fruit of goods 102 is entered using a user interface of point of sale device 126, and point of sale device 126 transmits the rating to integration program 142, to conclude ratings interaction 214. In one embodiment, person 104 enters the rating into point of sale device 126 (e.g., if point of sale device 126 is a self-checkout device, etc.), while in another embodiment person 106 enters the rating into point of sale device 126 (e.g., if point of sale device 126 is a staff assisted-checkout device, etc.). Notably, the performance of ratings interaction 214 thus does not require that ratings device 125 be configured to receive ratings, and as such in the context of ratings interaction 214 ratings device 125 can be an ordinary scale. Further, in such a context ratings device 125 can be omitted altogether, and goods 102 can be weighed, priced, and rated entirely at point of sale device 126.

During ratings interaction 216, a rating of goods 102 is communicated from mobile device 124 to integration program 142. For example, as above, person 104 can select a fruit of goods 102 and rate the fruit using a user interface of mobile device 124. Mobile device 124 transmits the rating to integration program 142, to conclude ratings interaction 216.

In the above discussion of ratings interactions 210, 212a, 212b, 214, and 216, a fruit of goods 102 is rated. However, instead of rating only the selected fruit, person 104 can rate all of goods 102 of the same type as the fruit. For example, person 104 can select a bunch of bananas from a display of many bunches at goods stand 121, and rate either the selected bunch or all of the bunches. The user interfaces of mobile device 124, ratings device 125, and point of sale device 126 discussed above in the context of ratings interactions 210, 212a, 212b, 214, and 216 can include buttons or graphics allowing person 104 to rate the fruit as ripe or unripe, or on a 10-point quality scale, for example. Of course, the examples related above discussing fruit are in no way limiting, and ratings interactions 210, 212a, 212b, 214, and 216 can be performed with diverse goods 102 including clothes, appliances, electronics, hardware, software, prepared meals, or any other type of goods 102.

During ratings interaction 220, a rating of goods 102, or a ratings digest, is communicated from distribution program 144 of ratings server 140 to computer 130. For example, person 108 can prepare for a shopping trip by requesting a ratings digest including information about items on his or her shopping list. The ratings digest can include information about where the highest rated goods 102 of a specific type are located, information about how the ratings of various goods 102 have changed over time, information about where the closest goods 102 that exceed a ratings threshold are located, or other information. If person 104 has rated fruit of goods 102 in purchase environment 120 highly, and if person 108 is preparing to shop for fruit of the same type, then distribution program 144 can include the rating made by person 104 in the information transmitted in ratings interaction 220.

As another example, in the context of ratings interaction 220, person 108 can be employed by the enterprise operating purchase environment 120. Person 108 can evaluate purchase environment 120 by requesting a rating of goods 102 or a ratings digest including information about some or all of goods 102 for sale in purchase environment 120. The information informs person 108 whether or not goods 102 for sale in purchase environment 120 are highly rated, so that person 108 can take action on behalf of the enterprise if they are not. In one embodiment, an absence of good ratings can be used by person 108 to infer that goods 102 are of poor quality because, for example, person 104 may not take the time to rate goods 102 after perusal if he or she finds them to be wanting. In one embodiment, computer 130 receives ratings interaction 220 and takes action on behalf of the enterprise without the participation of person 108, e.g., computer 130 can automatically take action depending on the ratings of goods 102 in purchase environment 120.

During ratings interaction 222, a rating of goods 102, or a ratings digest, is communicated from distribution program 144 of ratings server 140 to mobile device 124. For example, person 104, upon perusing goods 102 and finding goods 102 wanting, can request a ratings digest including information about the type of goods 102. Distribution program 144 can include ratings made by other people (not shown) in the information transmitted in ratings interaction 222, enabling person 104 to travel to a different purchase environment to locate better goods 102.

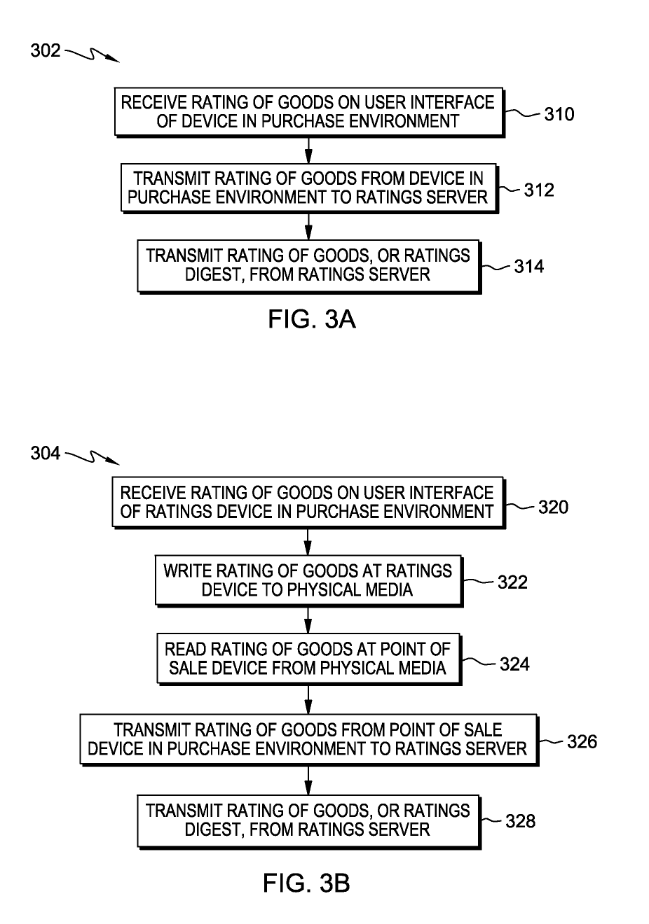

Referring now to FIGS. 3A and 3B, flowcharts 302 and 304 depicting steps followed during various of ratings interactions 210, 212a, 212b, 214, 216, 220, and 222 in accordance with an embodiment of the present invention are shown.

Turning now to FIG. 3A, in step 310 a rating of goods 102 is received on a user interface of a device in purchase environment 120. The device can be, for example, mobile device 124, ratings device 125, or point of sale device 126. In step 312, the device transmits the rating of goods 102 to ratings server 140. For example, mobile device 124 can make the transmission (i.e., ratings interaction 216), ratings device 125 can make the transmission (i.e., ratings interaction 210), or point of sale device 126 can make the transmission (i.e., ratings interaction 214). In step 314, ratings server 140 transmits the rating of goods 102, or a ratings digest to, e.g., mobile device 124 (i.e., ratings interaction 222) or computer 130 (i.e., ratings interaction 220).

Turning now to FIG. 3B, in step 320 a rating of goods 102 is received on a user interface of ratings device 125 in purchase environment 120. In steps 322 and 324, ratings device 125 writes the rating of goods 102 to physical media (e.g., prints a paper label, writes to a portable storage medium such as an RFID tag or flash drive, etc.) and point of sale device 126 reads the rating from the physical media (i.e., ratings interaction 212a). In step 326, point of sale device 126 transmits the rating of goods 102 to ratings server 140 (i.e., ratings interaction 212b). In step 328, ratings server 140 transmits the rating of goods 102, or a ratings digest to, e.g., mobile device 124 (i.e., ratings interaction 222) or computer 130 (i.e., ratings interaction 220).

Referring now to FIG. 4, a functional block diagram of a computer system in accordance with an embodiment of the present invention is shown. Computer system 400 is only one example of a suitable computer system and is not intended to suggest any limitation as to the scope of use or functionality of embodiments of the invention described herein. Regardless, computer system 400 is capable of being implemented and/or performing any of the functionality set forth hereinabove.

In computer system 400 there is computer 412, which is operational with numerous other general purpose or special purpose computing system environments or configurations. Examples of well-known computing systems, environments, and/or configurations that may be suitable for use with computer 412 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Each one of mobile device 124, ratings device 125, point of sale device 126, computer 130, and ratings server 140 can include or can be implemented as an instance of computer 412.

Computer 412 may be described in the general context of computer system executable instructions, such as program modules, being executed by a computer system. Generally, program modules may include routines, programs, objects, components, logic, data structures, and so on that perform particular tasks or implement particular abstract data types. Computer 412 may be practiced in distributed cloud computing environments where tasks are performed by remote processing devices that are linked through a communications network. In a distributed cloud computing environment, program modules may be located in both local and remote computer system storage media including memory storage devices.

As further shown in FIG. 4, computer 412 in computer system 400 is shown in the form of a general-purpose computing device. The components of computer 412 may include, but are not limited to, one or more processors or processing units 416, memory 428, and bus 418 that couples various system components including memory 428 to processing unit 416.

Bus 418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 412 typically includes a variety of computer system readable media. Such media may be any available media that is accessible by computer 412, and includes both volatile and non-volatile media, and removable and non-removable media.

Memory 428 can include computer system readable media in the form of volatile memory, such as random access memory (RAM) 430 and/or cache 432. Computer 412 may further include other removable/non-removable, volatile/non-volatile computer system storage media. By way of example only, storage system 434 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 418 by one or more data media interfaces. As will be further depicted and described below, memory 428 may include at least one program product having a set (e.g., at least one) of program modules that are configured to carry out the functions of embodiments of the invention.

Program 440, having one or more program modules 442, may be stored in memory 428 by way of example, and not limitation, as well as an operating system, one or more application programs, other program modules, and program data. Each of the operating system, one or more application programs, other program modules, and program data or some combination thereof, may include an implementation of a networking environment. Program modules 442 generally carry out the functions and/or methodologies of embodiments of the invention as described herein. Each one of integration program 142 and distribution program 144 can be implemented as or can be an instance of program 440.

Computer 412 may also communicate with one or more external devices 414 such as a keyboard, a pointing device, etc., as well as display 424; one or more devices that enable a user to interact with computer 412; and/or any devices (e.g., network card, modem, etc.) that enable computer 412 to communicate with one or more other computing devices. Such communication can occur via Input/Output (I/O) interfaces 422. Still yet, computer 412 can communicate with one or more networks such as a local area network (LAN), a general wide area network (WAN), and/or a public network (e.g., the Internet) via network adapter 420. As depicted, network adapter 420 communicates with the other components of computer 412 via bus 418. It should be understood that although not shown, other hardware and/or software components could be used in conjunction with computer 412. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for rating goods, the method comprising the steps of:
receiving, at a ratings device in a purchase environment, a rating of goods;
writing, at the ratings device in the purchase environment, the rating of goods to a physical medium;
reading, at a point of sale device in the purchase environment, the rating of goods from the physical medium; and
transmitting the rating of goods from the point of sale device in the purchase environment to a ratings server.

2. The method of claim 1, wherein the physical medium includes a label.

3. The method of claim 1, wherein the goods are perishable.

4. The method of claim 1, wherein the point of sale device includes a self-checkout device.

5. The method of claim 1, wherein the ratings device includes a scale for weighing the goods.

6. The method of claim 1, wherein the rating of goods is a rating of displayed goods in the purchase environment.

7. A system for rating goods, the system comprising:
a scale configured to weigh a portion of goods;
logic configured to price the portion of goods based at least in part on the weight of the portion of goods;
a user interface configured to receive a rating of goods of the type of the portion of goods; and
a writer configured to write the rating to a physical medium.

8. The system of claim 7, wherein the rating of goods is received from the user interface in a purchase environment.

9. The system of claim 7, wherein the rating of goods is a rating of the portion of goods.

10. The system of claim 7, wherein the rating of goods is a rating of displayed goods in a purchase environment.

11. The system of claim 7, wherein the user interface is further configured to receive contact information.

12. The system of claim 7, wherein the physical medium includes a label.

13. The system of claim 7, wherein the portion of goods is perishable.

14. A computer program product for rating goods, the computer program product comprising:
one or more computer-readable tangible storage devices and program instructions stored on at least one of the one or more storage devices, the program instructions comprising:
program instructions to weigh a portion of goods;
program instructions to price the portion of goods;
program instructions to receive a rating of goods of the type of the portion of goods; and
program instructions to write the rating to a physical medium.

15. The computer program product of claim 14, wherein the rating of goods is received from a user interface in a purchase environment.

16. The computer program product of claim 14, wherein the rating of goods is a rating of the portion of goods.

17. The computer program product of claim 14, wherein the rating of goods is a rating of displayed goods in a purchase environment.

18. The computer program product of claim 14, further comprising program instructions to receive contact information.

19. The computer program product of claim 14, wherein the physical medium includes a label.

20. The computer program product of claim 14, wherein the portion of goods is perishable.
